(19) United States
(12) Patent Application Publication
(10) Pub. No.: US 2026/0149017 A1
(43) Pub. Date: May 28, 2026

(54) METHOD OF DIAGNOSING LEAKAGE OF STACK COOLANT AND DEVICE THEREFOR

(71) Applicants: Hyundai Motor Company, Seoul (KR); Kia Corporation, Seoul (KR)

(72) Inventors: Joon Hwan KIM, Hwaseong-Si (KR); Hee Won KOO, Hwaseong-Si (KR)

(21) Appl. No.: 19/222,356

(22) Filed: May 29, 2025

(30) Foreign Application Priority Data
Nov. 26, 2024 (KR) 10-2024-0171387

(51) Int. Cl. H01M 8/04664; G01M 3/26; H01M 8/04302; H01M 8/0438; H01M 8/04537; H01M 8/04746; H01M 8/04858

(52) U.S. Cl. CPC H01M 8/04686; G01M 3/26; H01M 8/04302; H01M 8/04417; H01M 8/04559; H01M 8/04589; H01M 8/04671; H01M 8/04753; H01M 8/0491; H01M 8/0494; H01M 2250/20

(57) ABSTRACT

The present disclosure relates to a method of diagnosing leakage of a stack coolant in a fuel cell electric vehicle, and a device therefor. The method may include performing, based on detecting a coolant level of coolant storage in the fuel cell system, a first diagnosis of whether airtightness of a cooling line in the fuel cell system is abnormal; performing, based on the first diagnosing indicating that the airtightness of the cooling line is abnormal and based on voltage and current measurements of a fuel cell stack in the fuel cell system, a second diagnosis of contamination of the fuel cell stack due to leakage of a coolant in the coolant storage; and adjusting, based on the second diagnosis of contamination of the fuel cell stack, at least one operation of the fuel cell system that causes a contamination mitigation on the fuel cell stack.

### CROSS-REFERENCE TO RELATED APPLICATION

This application claims the benefit of priority to Korean Patent Application No. 10-2024-0171387, filed in the Korean Intellectual Property Office on Nov. 26, 2024, the entire contents of which are incorporated herein by reference.

### TECHNICAL FIELD

The present disclosure relates to a fuel cell electric vehicle, and more particularly, to a technology associated with leakage of a coolant in a fuel cell stack.

### BACKGROUND

Carbon neutrality is a topic of interest for many industries and policy makers around the world. Major economies are seeking ways for expanding electricity production using renewable energy instead of traditional fossil fuel energy.

An energy system that harnesses various forms of renewable energy such as wind power, hydro power, tidal power, and solar power and convert them into electrical or hydrogen energy is sometimes called a green energy system.

Among them, the so-called “green hydrogen” is considered by many to be the ultimate eco-friendly energy because it emits no greenhouse gas at a production stage. Hydrogen, which is emerging as an alternative energy of choice on a global scale, can be further classified into gray hydrogen, blue hydrogen, and green hydrogen depending on a production method.

As electric vehicles become more widely adopted, research on electric vehicles equipped with eco-friendly hydrogen fuel cells has been actively conducted.

Hydrogen fuel-based electric vehicles may provide a fast charging time and a long driving distance with a single hydrogen charge due to high energy density of hydrogen fuel as compared to electric vehicles equipped with high-voltage batteries.

In a fuel cell system, a stack heat management is one of the most important technical challenges that should be considered first in system design. In a fuel cell stack, it is important to effectively remove heat that is inevitably generated by a chemical reaction so that temperature distribution of a membrane electrode assembly in the stack may be maintained uniformly. To this end, an appropriate cooling system needs to be applied according to capacity of a fuel cell to be designed.

A cooling method of the stack may include radiator cooling using a radiator, air cooling using air flow, liquid cooling using a liquid coolant, and the like.

Causes of degradation in performance of the stack may be classified as degradation of a cell itself such as a membrane electrode assembly (MEA) and degradation due to external factors. The deterioration of the cell itself may be caused by an electrochemical reaction in the cell, and thus is a factor that is inevitable and difficult, if not impossible, to mitigate. But the deterioration due to the external factors is a factor that should be avoided as much as possible, and should be quickly diagnosed and analyzed and efficiently taken when the deterioration due to the external factors has already occurred.

With the liquid cooling method, if poisoning occurs due to leakage of a coolant in the stack, serious performance degradation may occur.

Thus, there is room for improvement in the technology for diagnosing a state of the leakage of the coolant and minimizing poisoning if the leakage of the coolant is diagnosed.

The matters described in this Background section are only for enhancement of understanding of the background of the disclosure, and should not be taken as acknowledgment that they correspond to prior art already known to those skilled in the art.

### SUMMARY

The present disclosure has been made to solve the above-mentioned problems occurring in at least some implementations while advantages achieved by those implementations are maintained intact.

An aspect of the present disclosure provides a method of diagnosing leakage of a stack coolant in a fuel cell electric vehicle, and a device therefor.

Another aspect of the present disclosure provides a fuel cell electric vehicle capable of automatically performing poisoning mitigation operation logic when introduction of a coolant into a stack is detected based on a change of an electrical state in the stack, and a method of controlling the same.

Still another aspect of the present disclosure provides a method of diagnosing leakage of a stack coolant in a fuel cell electric vehicle capable of preventing additional degradation of a stack by inducing quick inspection and repair by diagnosing whether the coolant is introduced into the stack as well as whether airtightness of a fuel cell cooling system is abnormal and by outputting a warning alarm according thereto, and a device therefor.

The technical problems to be solved by the present disclosure are not limited to the aforementioned problems, and any other technical problems not mentioned herein will be clearly understood from the following description by those skilled in the art to which the present disclosure pertains.

According to one or more example embodiments of the present disclosure, a method performed by an apparatus of a fuel cell system may include: performing, based on detecting a coolant level of coolant storage in the fuel cell system, a first diagnosis of whether airtightness of a cooling line in the fuel cell system is abnormal; performing, based on the first diagnosing indicating that the airtightness of the cooling line is abnormal and based on voltage and current measurements of a fuel cell stack in the fuel cell system, a second diagnosis of contamination of the fuel cell stack due to leakage of a coolant in the coolant storage; and adjusting, based on the second diagnosis of contamination of the fuel cell stack, at least one operation of the fuel cell system that causes a contamination mitigation on the fuel cell stack.

The first diagnosis may include: determining a threshold coolant reduction amount corresponding to a time duration of a most recent drive session, before a present drive session, of the fuel cell system; determining a difference between a first coolant level corresponding to a first start-up time of the most recent drive session before the present drive session and a second coolant level at a second start-up time of the present drive session; and diagnosing that the airtightness is abnormal based on the difference and the threshold coolant reduction amount.

The first diagnosis may further include: determining a first coolant expansion coefficient corresponding to a first outside air temperature at the first start-up time; determining a second coolant expansion coefficient corresponding to a second outside air temperature at the second start-up time; adjusting, based on the first coolant expansion coefficient, the first coolant level; adjusting, based on the second coolant expansion coefficient, the second coolant level; and diagnosing the airtightness of the cooling line to be abnormal based on a difference, between the adjusted first coolant level and the adjusted second coolant level, and the threshold coolant reduction amount.

Diagnosing that the airtightness is abnormal may be further based on the difference being greater than the threshold coolant reduction amount by more than a predetermined ratio. The predetermined ratio may be 5%.

The second diagnosis may include: performing, based on a channel-specific voltage of the fuel cell stack, a first contamination diagnosis to identify a cell, of the fuel cell stack, that is suspected of contamination; and performing a second contamination diagnosis based on a distribution of a segment current of the cell suspected of contamination.

The first contamination diagnosis may include: identifying the cell to be suspected of contamination, based on the cell belonging to a channel among one or more channels of the fuel cell stack. A voltage of the channel during a present drive session of the fuel cell system may be is less than: a voltage of the channel during a most recent drive session, before the present drive session, of the fuel cell system, and a target voltage corresponding to a predetermined operating current density of the fuel cell system.

The second poisoning diagnosis may include: confirming the cell suspected of contamination as a confirmed contaminated cell based on at least one of: a decrease ratio of a first minimum value, during a present drive session of the fuel cell system, of the segment current relative to a second minimum value, during a most recent drive session of the fuel cell system before the present drive session, of the segment current, or an increase ratio of a first standard deviation, during the present drive session, of the segment current relative to a second standard deviation, during the most recent drive session, of the segment current.

The contamination mitigation may include at least one of: limiting a maximum output of the fuel cell stack to a first reference value or less; controlling a current of the fuel cell stack such that the fuel cell stack generates water at a predetermined level or greater; or increasing fuel supply of the fuel cell stack.

The method may further include: outputting, via an output interface and based on the first diagnosis and the second diagnosis, a warning alarm.

The output interface may include at least one of: an instrument panel, a head-up display, an audio video navigation (AVN), or a speaker. Outputting the warning alarm may include outputting the warning alarm based on a detected repair status of the fuel cell stack.

According to one or more example embodiments of the present disclosure, an apparatus may include: a processor; and

a memory storing at least one instruction that is configured, when executed by the processor communicating with the memory, to cause the apparatus to: diagnose, based on detecting a coolant level of coolant storage in a fuel cell system of a fuel cell system, whether airtightness of a cooling line in the fuel cell system is abnormal; diagnose, based on the airtightness of the cooling line being diagnosed as being abnormal and based on voltage and current measurements of a fuel cell stack in the fuel cell system, contamination of the fuel cell stack due to leakage of a coolant in the coolant storage; and adjust, based on the diagnosing of contamination of the fuel cell stack, at least one operation of the fuel cell system that causes a contamination mitigation operation on the fuel cell stack.

The at least one instruction may be configured, when executed by the processor communicating with the memory, to cause the apparatus to diagnose whether the airtightness is abnormal by: determining a threshold coolant reduction amount corresponding a time duration of a most recent drive session, before a present drive session, of the fuel cell system; determining a difference between a first coolant level corresponding to a first start-up time of the most recent drive session before the present drive session and a second coolant level at a second start-up time of the present drive session; and diagnosing that the airtightness is abnormal based on the difference and the threshold coolant reduction amount.

The at least one instruction may be configured, when executed by the processor communicating with the memory, to cause the apparatus to diagnose whether the airtightness is abnormal further by: determining a first coolant expansion coefficient corresponding to a first outside air temperature at the first start-up time; determining a second coolant expansion coefficient corresponding to a second outside air temperature at the second start-up time; and adjusting, based on the first coolant expansion coefficient, the first coolant level; adjusting, based on the second coolant expansion coefficient, the second coolant level; and diagnosing the airtightness of the cooling line to be abnormal based on a difference, between the adjusted first coolant level and the adjusted second coolant level, and the threshold coolant reduction amount.

Diagnosing that the airtightness is abnormal may be further based on the difference being greater than the threshold coolant reduction amount by more than a predetermined ratio. The predetermined ratio may be 5%.

The at least one instruction may be configured, when executed by the processor communicating with the memory, to cause the apparatus to diagnose contamination of the fuel cell stack by: performing, based on a channel-specific voltage of the fuel cell stack, a first contamination diagnosis to identify a cell, of the fuel cell stack, that is suspected of contamination; and performing a second contamination diagnosis based on a distribution of a segment current of the cell suspected of contamination.

The at least one instruction may be configured, when executed by the processor communicating with the memory, to cause the apparatus to perform the first contamination diagnosis by: identifying the cell to be suspected of contamination, based on the cell belonging to a channel among one or more channels of the fuel cell stack. A voltage of the channel during a present drive session of the fuel cell system may be less than: a voltage of the channel during a most recent drive session, before the present drive session, of the fuel cell system, and a target voltage corresponding to a predetermined operating current density of the fuel cell system.

The at least one instruction may be configured, when executed by the processor communicating with the memory, to cause the apparatus to perform the second contamination diagnosis by: confirming the cell suspected of contamination as a confirmed poisoned cell based on at least one of: a decrease ratio of a first minimum value, during a present drive session of the fuel cell system, of the segment current relative to a second minimum value, during a most recent drive session of the fuel cell system before the present drive session, of the segment current, or an increase ratio of a first standard deviation, during the present drive session, of the segment current relative to a second standard deviation, during the most recent drive session, of the segment current.

The at least one instruction may be configured, when executed by the processor communicating with the memory, to cause the apparatus to perform the contamination mitigation operation by at least one of: limiting a maximum output of the fuel cell stack to a first reference value or less; controlling a current of the fuel cell stack such that the fuel cell stack generates water at a predetermined level or greater; or increasing fuel supply of the fuel cell stack.

The at least one instruction is configured, when executed by the processor communicating with the memory, to further cause the apparatus to: output, via an output interface and based on the diagnosing of contamination of the fuel cell stack, a warning alarm. The output interface may include at least one of an instrument panel, a head-up display, an audio video navigation (AVN), or a speaker.

According to one or more example embodiments of the present disclosure, a vehicle may include: a fuel cell system including a fuel cell stack; a processor; and a memory storing at least one instruction that is configured, when executed by the processor communicating with the memory, to cause the vehicle to: determine, based on detecting a coolant level of coolant storage in the fuel cell system and based on at least one measurement associated with a physical characteristic of the fuel cell stack, contamination of the fuel cell stack due to leakage of a coolant in the coolant storage; adjust, based on the determined contamination of the fuel cell stack, at least one operation of the fuel cell system that causes a contamination mitigation operation on the fuel cell stack; and control, based on the adjusted at least one operation of the fuel cell system, an operation of the vehicle. The at least one measurement may include at least one of a voltage measurement associated with the fuel cell stack or a current measurement associated with the fuel cell stack.

### BRIEF DESCRIPTION OF THE DRAWINGS

The above and other objects, features and advantages of the present disclosure will be more apparent from the following detailed description taken in conjunction with the accompanying drawings:

FIG. 1 is a view for describing a structure of a fuel cell system, diagnosis of leakage of a coolant, and an operation of mitigating poisoning;

FIG. 2 is a view for describing an electrochemical reaction in a fuel cell stack;

FIG. 3 is a view for describing a structure of a fuel cell system, diagnosis of leakage of a coolant, and an operation of mitigating poisoning;

FIG. 4 is a view for describing a process control loop;

FIG. 5 is a block diagram for describing a structure of a main processor;

FIG. 6 is a flowchart for describing a method of diagnosing leakage of a coolant in the fuel cell system;

FIG. 7 is a flowchart for describing the method of diagnosing leakage of a coolant in the fuel cell system;

FIG. 8 illustrates a poisoning principle test result;

FIG. 9 is a graph depicting degradation recovery performance according to a poisoning mitigation operation; and

FIG. 10 illustrates a computing device.

### DETAILED DESCRIPTION

Hereinafter, one or more example embodiments of the present disclosure will be described in detail with reference to the exemplary drawings. In adding reference numerals to components of each drawing, it should be noted that identical or equivalent components are designated by an identical numeral even when they are displayed on other drawings. Further, in describing the example embodiments of the present disclosure, a detailed description of the related known configuration or function will be omitted when it is determined that it interferes with the understanding of the example embodiments of the present disclosure.

In describing the components of the one or more example embodiments according to the present disclosure, terms such as first, second, A, B, (a), (b), and the like may be used. These terms are merely intended to distinguish one component from other components, and the terms do not limit the nature, order, or sequence of the components. Unless otherwise defined, all terms including technical and scientific terms used herein include the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

The term “part,” “device,” “module” or “unit” used in the specification means a software and/or hardware component, and the part,” “device,” “module” or “unit” performs certain operations/functions/roles. However, the part,” “device,” “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the part,” “device,” “module” or “unit” may be realized as controller circuitry, a controller circuit, a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

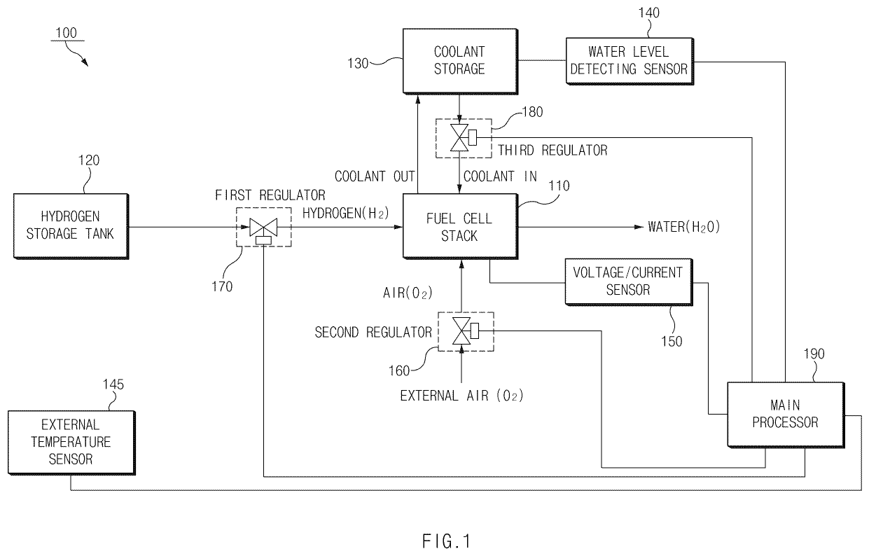

Hereinafter, one or more example embodiments of the present disclosure will be described in detail with reference to FIGS. 1 to 10.

FIG. 1 is a view for describing a structure of a fuel cell system, diagnosis of leakage of a coolant, and an operation of mitigating contamination (e.g., poisoning, such as CO poisoning, NH3 poisoning, H2S poisoning, SO2 poisoning, etc.). Hereinafter, contamination (e.g., contamination associated with the fuel cell system) may be referred to as poisoning.

Referring to FIG. 1, a fuel cell system (or a fuel cell vehicle system) 100 may include at least one of a fuel cell stack 110, a hydrogen storage tank (also referred to as hydrogen storage) 120, coolant storage 130, a level sensor (also referred to as a liquid level sensor, a liquid sensor, a level sensor, a water level detecting sensor, etc.) 140, an external temperature sensor 145, a voltage/current sensor 150, a first regulator 170, a second regulator 160, a third regulator 180, and a main processor 190.

The fuel cell stack 110 may generate power by performing an electrochemical reaction using, as fuel, hydrogen (H₂) introduced from the hydrogen storage tank 120 and air introduced from outside a vehicle. The air may include oxygen (O₂). The generated power may be used to charge a vehicle battery (not illustrated) and drive a motor (not illustrated) provided in the vehicle.

The fuel cell stack 110 may generate heat through an electrochemical reaction. The fuel cell stack 110 may reduce the generated internal heat to a predetermined level or less by using a coolant introduced from the coolant storage 130. As an example, the coolant may be produced by mixing pure water with an antifreeze (e.g., ethylene glycol, hereinafter referred to as “EG”), in a predetermined ratio. Thus, stack poisoning may actually occur due to leakage of the antifreeze. The configuration of the coolant is merely an example, and the type of coolant applied to the fuel cell system 100 may be different depending on implementation of those skilled in the art. In the context of fuel cells, poisoning may refer to a coolant being leaked inside the fuel cell stack, thus contaminating the fuel cell stack. Poisoning (e.g., contamination) may reduce one or more cells of the fuel cell stack to degrade in activity, performance, and/or lifespan.

The amount of the hydrogen introduced into the fuel cell stack 110 may be adjusted through the first regulator 170, the amount of the air may be adjusted through the second regulator 160, and the amount of the coolant may be adjusted through the third regulator 180.

The main processor 190 may control the amount of outputs of the first to third regulators 160 to 180.

The level sensor 140 may measure a level of the coolant of the coolant storage 130 and provide the measurement result to the main processor 190. The main processor 190 may obtain information on the current level of the coolant by requesting the level sensor 140 to measure the level of the coolant through a predetermined control command immediately after starting.

The voltage/current sensor 150 may measure a channel-specific voltage and a current in a cell-specific segment unit in a channel of the fuel cell stack 110 and provide the measurement result to the main processor 190. One channel may include a plurality of cells, and one cell may include of a plurality of segments. The main processor 190 may request the voltage/current sensor 150 to measure a voltage and/or a current through a predetermined control command and obtain information on a current voltage and/or current distribution in the fuel cell stack 110.

The external temperature sensor 145 may measure an outside air temperature and provide the measurement result to the main processor 190. The main processor 190 may obtain information on the current outside air temperature by requesting the external temperature sensor 145 to measure the outside air temperature through a predetermined control command after starting.

The main processor 190 may diagnose whether the coolant leaks from inside and/or outside the fuel cell stack 110 based on the sensing information collected from at least one sensor of the level sensor 140, the voltage/current sensor 150, and the external temperature sensor 145.

The main processor 190 may perform a poisoning mitigation operation (also referred to as poison mitigation, poisoning mitigation, or a poisoning minimizing operation) of controlling the amount of output of at least one of the first to third regulators 160 to 180 based on the diagnosis result of whether the coolant leaks from inside and/or outside the fuel cell stack 110.

The method of diagnosing leakage of a coolant and the method of poisoning mitigation by the main processor 190 will become clearer through the following description of the accompanying drawings.

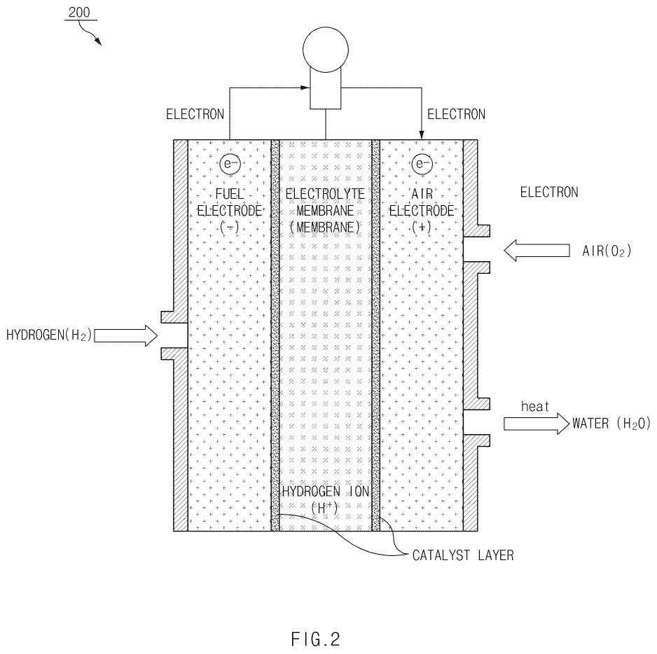

FIG. 2 is a view for describing an electrochemical reaction in a fuel cell stack according to the present disclosure,

Referring to FIG. 2, a fuel cell system 200 may roughly include a fuel electrode as a negative electrode (e.g., anode), an air electrode as a positive electrode (e.g., cathode), and an electrolyte membrane disposed between the fuel electrode and the air electrode.

In a stack of the fuel cell system 200, hydrogen injected into the fuel electrode and oxygen injected into the air electrode may react electrochemically so as to constantly generate water, which may be referred to as generation water (H₂O) (e.g., electrolyzed water).

Catalyst layers may be formed on either side (e.g., front and back) of the electrolyte membrane to allow a chemical reaction to occur in the fuel cell stack. For example, the catalyst layers may be formed using carbon powder coated with a platinum (Pt)-based catalyst, but this is merely an example, and other catalyst materials may be used depending on a design of those skilled in the art. The catalyst layers may form a gas diffusion layer (hereinafter, referred to as “GDL”) using a catalyst.

The hydrogen and the oxygen injected to a left side (e.g., the fuel electrode side) and a right side (e.g., the air electrode side) of the stack are ionized through oxidation and reduction processes.

When hydrogen gas (H₂) is injected through a hydrogen inlet formed at one location on the fuel electrode, the hydrogen may react with the catalyst and is be decomposed into hydrogen ions (H⁺) and electrons (e⁻). This reaction may be represented by the chemical reaction formula, 2H₂→4H⁺+4e⁻.

The hydrogen ions pass may through the electrolyte membrane and move to the air electrode. The electrons generated from the fuel electrode may pass through an external circuit and generate a current. In this case, a motor of an electric vehicle may be driven (e.g., powered) and a battery may be charged using the generated current.

When oxygen (O₂) is injected through an air inlet formed at one location on the air electrode, the oxygen (O₂) and electrons (4e⁻) may react with the help of the catalyst to generate oxygen ions (2O²⁻). The generated oxygen ions (2O²⁻) and hydrogen ions (4H⁻) passing through the electrolyte membrane may react to generate water (2H₂O). The water and heat generated during the chemical reaction in the cell may be discharged out of the fuel cell stack through a water outlet formed at another location on the air electrode.

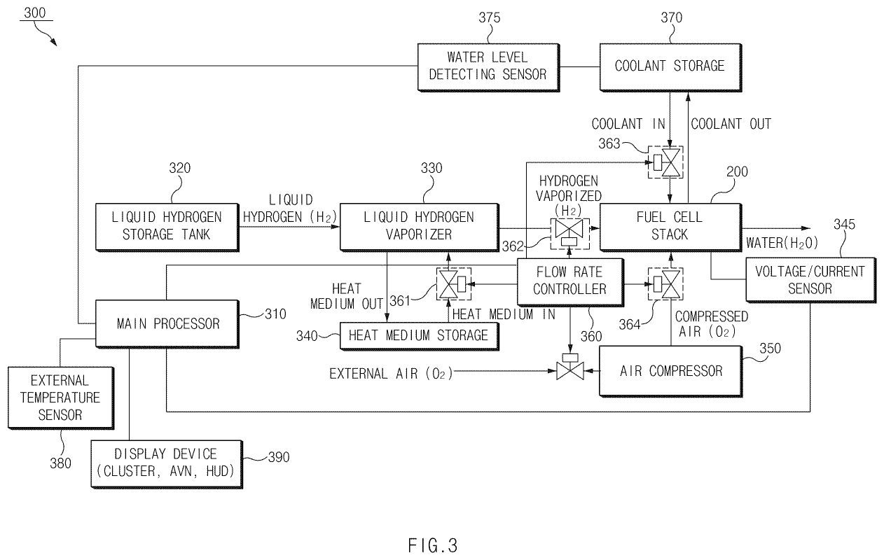

FIG. 3 is a view for describing a structure of a fuel cell system, diagnosis of leakage of a coolant, and an operation of mitigating poisoning.

Referring to FIG. 3, a fuel cell system (or a fuel cell vehicle system) 300 may include at least one of a main processor 310, a liquid hydrogen storage tank 320, a liquid hydrogen vaporizer 330, heat medium storage 340, a fuel cell stack 200, a voltage/current sensor 345, an air compressor 350, a flow rate controller 360, a first regulator 361, a second regulator 362, a third regulator 363, a fourth regulator 364, coolant storage 370, a level sensor 375, an external temperature sensor 380, and a display device 390.

Liquid hydrogen stored in the liquid hydrogen storage tank 320 may be vaporized by the liquid hydrogen vaporizer 330 and then supplied to the fuel cell stack 200.

The liquid hydrogen vaporizer 330 may receive a heat medium from the heat medium storage 340, convert the liquid hydrogen into a gas, and output the gas.

The air compressor 350 may compress external air and supply the compressed external air to the fuel cell stack 200.

The coolant stored in the coolant storage 370 may be supplied to the fuel cell stack 200.

The fuel cell stack 200 may generate power by performing an electrochemical reaction using, as fuel, the vaporized hydrogen (H₂) supplied through the liquid hydrogen vaporizer 330 and the compressed air supplied through the air compressor 350. Oxygen (O₂) may be included in the compressed air. The generated power may be used to charge the vehicle battery (not illustrated) and drive the motor (not illustrated) provided in the vehicle.

The fuel cell stack 200 may generate heat during the electrochemical reaction. The fuel cell stack 200 may reduce heat generated therein to a predetermined level or less using the coolant introduced from the coolant storage 370 through a cooling line (also referred to as a coolant line).

The main processor 310 may transmit a predetermined control command to the flow rate controller 360 to adjust the amount of the vaporized hydrogen, the amount of the external air, the amount of the compressed air, and the amount of the coolant supplied to the fuel cell stack 200. The flow rate controller 360 may adjust the amount of fuel and the amount of the coolant supplied to the fuel cell stack 200 by adjusting output of at least one of the second to fourth regulators 362 to 364 according to a control signal of the main processor 310.

The amount of the hydrogen introduced into the fuel cell stack 200 may be adjusted through the second regulator 362, the amount of the air may be adjusted through the fourth regulator 364, and the amount of the coolant may be controlled through the third regulator 363.

The main processor 310 may transmit a predetermined control command to the flow rate controller 360 to control the amount of a heat medium supplied to the liquid hydrogen vaporizer 330. The flow rate controller 360 may adjust the amount of the supplied heat medium by adjusting the first regulator 361 according to the control command from the main processor 310.

The level sensor 375 may measure a level of the coolant of the coolant storage 370 and provide the measurement result to the main processor 310. The main processor 310 may obtain information on the current level of the coolant by requesting the level sensor 375 to measure the level of the coolant through a predetermined control command after starting.

The voltage/current sensor 345 may measure a channel-specific voltage and a current in a cell-specific segment unit in a channel of the fuel cell stack 200 and provide the measurement result to the main processor 310. The main processor 310 may request the voltage/current sensor 345 to measure a voltage and/or a current through a predetermined control command and obtain information on a current voltage and/or current distribution in the fuel cell stack 200.

The external temperature sensor 380 may measure the outside air temperature and provide the measurement result to the main processor 310. The main processor 310 may obtain information on the current outside air temperature by requesting the external temperature sensor 380 to measure the outside air temperature through a predetermined control command after starting.

The main processor 310 may diagnose whether the coolant leaks from inside/outside the fuel cell stack 200 based on the sensing information collected from at least one sensor of the level sensor 375, the voltage/current sensor 345, and the external temperature sensor 380.

The main processor 310 may perform an operation of mitigating poisoning by controlling the amount of output of at least one of the second to fourth regulators 362 to 364 based on the diagnosis result of whether the coolant leaks from inside/outside the fuel cell stack 200.

The main processor 310 may perform a control to generate a predetermined warning alarm message according to the result of diagnosing whether the coolant leaks from inside/outside the fuel cell stack 200 and then output the generated predetermined warning alarm message to the display device 390 provided on one side of the vehicle.

The detailed method of diagnosing leakage of a coolant and the detailed method of poisoning mitigation by the main processor 310 will become clearer through the following description of the accompanying drawings.

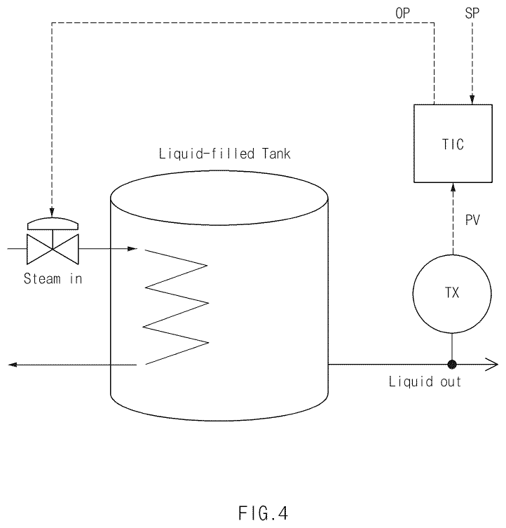

FIG. 4 is a view for describing a process control loop.

A hardware and/or software component for forming a process control loop may roughly include a controller (C), a control element (CE), and a measurement element (ME).

A control variable for the process control loop may roughly include a set point (SP), a process variable (or a measurement variable) (PV (or MV)), and an output (OP). The SP may be a value set by the controller, the PV or the MV may be a value transmitted by the measurement element to the controller, and the OP may be a value transmitted by the controller to the control element.

The SP may be a desired value for a process output. The SP may be preset by an operator of a corresponding system, calculated during system operation, or set based on a signal received from an external source.

The PV or the MV may be a measurement value for the process output.

The OP may be a variable for controlling an actuator that is a control element or for controlling another controller and is output of the controller.

A simple single input-single output (SISO) feedback control loop for controlling a temperature of a fluid will be described with reference to FIG. 4.

A temperature measuring sensor (TX) may measure the temperature of the fluid discharged from a liquid-filled tank and transmit a measurement temperature value (PV) to a temperature indicator and controller (TIC). The TIC may determine the OP based on the set SP value and the set PV value and may adjust a steam flow control valve using the determined OP. That is, the TIC may control the temperature of the fluid discharged from a tank by adjusting the amount of steam flowing into the tank.

Although the process control loop for controlling the temperature of the fluid has been described in connection with FIG. 4, the process control loop according to the present disclosure may be used to control not only the temperature of the fluid, but also a density (pressure) of the fluid and flow (e.g., flow rate) of the fluid.

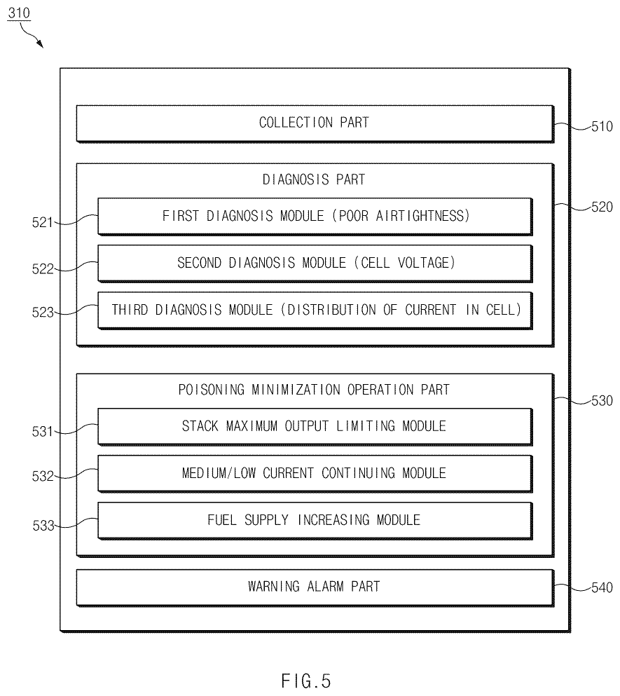

FIG. 5 is a block diagram for describing a structure of a main processor included in a computing device.

Referring to FIG. 5, the main processor 310 may include at least one of a collection part 510 (also referred to as a collection device 510), a diagnosis part 520 (also referred to as a diagnosis device 520), a poisoning minimization operation part 530 (also referred to as a poisoning mitigation device 530), and a warning alarm part 540 (also referred to as a warning alarm device 540). Each of the components shown in FIG. 5 may be implemented with software (e.g., instructions, stored in memory, that cause the processor 310 and/or other components described throughout the disclosure), hardware, or a combination of both. The warning alarm part 540 may comprise a speaker or a display.

The collection device 510 may collect information on a value obtained by measuring the level of the coolant of the coolant storage 130 or 370 from the level sensor 140 or 385 and information on a value obtained by measuring a channel-specific voltage and a value obtained by measuring a segment-specific current from the voltage/current sensor 150 or 345, after the vehicle starts up.

The diagnosis device 520 may perform an airtightness (e.g., seal) abnormality diagnosis (e.g., diagnosis of whether the coolant is leaking outside the stack) and a poisoning diagnosis (e.g., diagnosis of whether the coolant is leaking inside the stack) based on the information received from the collection device 510.

The diagnosis device 520 may include a first diagnosis module 521, a second diagnosis module 522, and a third diagnosis module 523.

The first diagnosis module 521 may identify an operating time at previous driving and calculate a normal coolant reduction amount d_t corresponding to the identified operating time in a coolant non-leakage state (e.g., a normal operating state).

The first diagnosis module 521 may determine a coolant expansion coefficient a1 corresponding to the outside air temperature at an immediately previous start-up time (e.g., a start-up time of a most recent drive session before the current drive session or a most recent trip before the current trip) and a coolant expansion coefficient a2 corresponding to the outside air temperature at a current start-up time (e.g., a start-up time of a current drive session or a current trip). The current start-up time may be a start-up time of a current drive session (also referred to as a current trip, a present drive session, a present trip). The immediately previous start-up time may be a start-up time of a most recent drive session (also referred to as a most recent trip) before the current drive session. The coolant expansion coefficient(s) according to the outside air temperature(s) may be recorded and maintained in the form of a table inside the main processor 310 or in a memory (not illustrated) separately provided and connected thereto. Further, information collected from the sensors and information on the diagnosis results may be maintained in the memory (not illustrated) for a certain period of time.

The first diagnosis module 521 may convert a coolant level h1 at the immediately previous start-up time (e.g., a start-up time of a most recent drive session before the current drive session or a most recent trip before the current trip) and a coolant level h2 at the current start-up time (e.g., a start-up time of a current drive session or a current trip) into coolant levels h1_ref and h2_ref at a reference temperature (e.g., 18 degrees). The first diagnosis module 521 may convert the coolant level h1 and the coolant level h2 into the coolant levels H1_ref and H2_ref, for example, based on the determined coolant expansion coefficients a1 and a2, respectively.

The first diagnosis module 521 may calculate d1, which is a difference value between the converted two coolant levels. The difference value d1 may be calculated by d1_ref d2_ref.

The first diagnosis module 521 may diagnose that the coolant airtightness (e.g., seal for the coolant) is poor (or abnormal) if d1, which is the level difference value obtained in consideration of the coolant expansion coefficient, is greater than the normal coolant reduction amount d_t (e.g., if the coolant level decreases by more than the normal coolant reduction amount) by a certain ratio (e.g., 5%) or more.

The first diagnosis module 521 may calculate a coolant reduction amount d2 based on a difference value between the coolant level h1 at the immediately previous start-up time (e.g., a start-up time of a most recent drive session before the current drive session or a most recent trip before the current trip) and the coolant level h2 at the current start-up time (e.g., a start-up time of a current drive session or a current trip).

The first diagnosis module 521 may adjust (e.g., correct) the coolant reduction amount d2 to an actual coolant reduction amount (also referred to as an adjusted coolant reduction amount) d2_mod in consideration of the coolant expansion coefficient a1 corresponding to the outside air temperature at the immediately previous start-up time (e.g., a start-up time of a most recent drive session before the current drive session or a most recent trip before the current trip) and the coolant expansion coefficient a2 corresponding to the outside air temperature at the current start-up time (e.g., a start-up time of a current drive session or a current trip). For example, the coolant level h1 may be adjusted (e.g., corrected) based on the coolant expansion coefficient a1, and the coolant level h2 may be adjusted (e.g., corrected) based on the coolant expansion coefficient a2 before the actual coolant reduction amount d2_mod is determined. The first diagnosis module 521 may also diagnose that the coolant airtightness is poor (or abnormal) when d2_mod, which is the level difference value obtained in consideration of the coolant expansion coefficient, is greater than the normal coolant reduction amount d_t by a certain ratio (e.g., 5%) or more.

The second diagnosis module 522 may identify a channel in which an abnormal voltage reduction occurs, based on the value obtained by measuring the channel-specific voltage at a predetermined operating current density. As an example, the operating current density may be 0.48 A/cm², which is a current density widely used for actual vehicle driving, but this is merely an example, and different operating current densities may be applied according to a design of those skilled in the art.

As an example, the second diagnosis module 522 may diagnose a channel having a voltage that is smaller than a target voltage corresponding to the corresponding operating current density by a certain level (e.g., 5%) or more, as a channel having an abnormal voltage reduction.

If the voltage of the channel, diagnosed as the channel having an abnormal voltage reduction, is decreased by a certain ratio (e.g., 5%) or more, as compared to an immediately previous operation, the second diagnosis module 522 may diagnose cells of the corresponding channel as poisoning suspected cells (or short-term abnormal degradation cells).

The third diagnosis module 523 may perform poisoning confirming diagnosis based on current distribution of the cells diagnosed as poisoning suspected cells.

The third diagnosis module 523 may compare current distribution C_pre at the immediately previous operation with current distribution C_cur at a current initial start-up operation at the same current density for the poisoning suspected cell and diagnose the corresponding cell as a poisoning confirmed cell based on the comparison result. As an example, the same current density may be set to 1.0 A/cm², but the present disclosure is not limited thereto. The reason why 1.0 A/cm² is selected is that a single current deviation may occur due to flooding in a cell in a low current condition, and the reason why the initial start-up operation is used as a criterion for the determination is that the initial start-up operation is estimated as a state in which CSD (in-cell water removal logic) measures are taken when the immediately previous operation is terminated and an influence on a current deviation due to distribution of water in the cell is lowest.

The third diagnosis module 523 may measure a segment-specific current in the cell in correspondence with C_pre and C_cur. When a standard deviation C_cur_std_dev of the segment current (also referred to as the segment electric current) corresponding to C_cur increases by 200% or more further than the a deviation C_pre_std_dev of the segment current corresponding to C_cur, and a segment current minimum value C_cur_seg_min corresponding to C_pre decreases by 20% compared to a segment current minimum value C_pre_seg_min corresponding to C_pre, the third diagnosis module 523 may determine that the corresponding cell is in an abnormal current distribution state. The third diagnosis module 523 may diagnose the cell in the abnormal current distribution state as the poisoning confirmed cell.

When a specific cell is diagnosed as the poisoning confirmed cell, the poisoning mitigation device 530 may perform poisoning mitigation.

When a small amount of the coolant is poisoned in the fuel cell stack, reversible performance degradation occurs, and thus, cell degradation may be recovered by quick action, but when the coolant is continuously exposed (continuously leaks), irreversible degradation may occur due to loss of electrodes and ionomers, and thus quick action is required.

A poisoning mitigation operation mode according to the present disclosure may be a mode of reducing additional coolant exposure (or poisoning) that will occur later in a state in which some of the cells are poisoned due to leakage of the coolant and discharging the currently poisoned coolant to the outside as much as possible.

The poisoning mitigation device 530 may include at least one of a stack maximum output limiting module 531, a medium/low current continuing module 532, and a fuel supply increasing module 533.

The stack maximum output limiting module 531 may control the coolant in the stack to circulate to a minimum by limiting high power generation of the stack. As an example, the stack maximum output limiting module 531 may control the coolant in the stack to circulate to a minimum by controlling a revolution per minute (RPM) of a cooling stack pump to be low. In general, under a high power operation condition, the amount of circulating coolant may increase, and accordingly, a possibility that the coolant leaks to a reaction part increases.

The medium/low current continuing module 532 may control the stack to continuously generate power using a certain current (e.g., a medium/low current), so that generation water having a certain level or more is continuously generated. That is, the medium/low current continuing module 532 may quickly restore performance of the stack degraded by EG leakage by discharging the EG covered with a platinum catalyst to the outside of the stack by inducing water generation and discharge without additional coolant inflow in a state in which a small amount of the coolant is positioned.

The fuel supply increasing module 533 may quickly restore the performance of the degraded stack by increasing supply amounts of the hydrogen and the air and blowing the coolant remaining in a separation plate and a GDL space to the outside of the stack

As an example, if a low power/low current density standard may be set to 0.16 A/cm, 14.4 g/hour of water may be generated per cell, and 3.17 kg/hour of water may be generated in sub-stack units.

In this way, the absolute amount of generated water may be calculated preliminarily, and the amount of the generated water and the amount of the discharged water may be adjusted according to an intensity of the current and the amount of supplied gas.

The warning alarm device 540 may output a predetermined warning alarm message according to the diagnosis result of the diagnosis device 520. The warning alarm device 540 may be an output interface. The warning alarm device 540 may be a display, an audio interface, or a combination of both. The warning alarm device 540 may be at least one of an instrument panel, an audio visual navigation (AVN), a head up display (HUD), and/or a speaker of the vehicle.

It should be noted that the above-described quantitative criteria for the diagnosis as shown in FIG. 5 (e.g., 5% or more, 200% or more, a start-up time, an immediately previous operating time, etc.) are merely one set of examples and may be variably applied through actual vehicle tuning.

Further, it should be noted that the above-described quantitative values for poisoning mitigation as shown in FIG. 5 (e.g., a hydrogen supercharge rate, an oxygen supercharge rate, an output limiting value) may be optimally derived and applied through actual vehicle tuning.

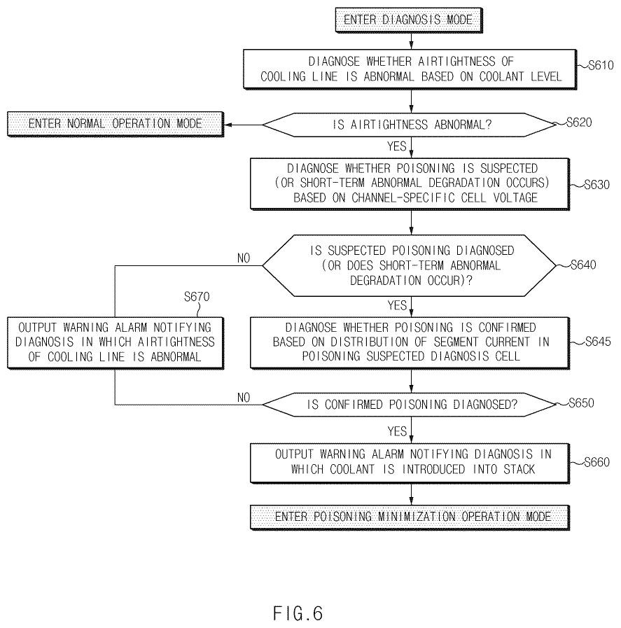

FIG. 6 is a flowchart for describing the method of diagnosing leakage of a coolant in the fuel cell system.

In detail, FIG. 6 may be a method performed by the main processor 190 or 310 of the fuel cell system described above with reference to the drawings. In the following description, an example in which the method of FIG. 6 is performed by the main processor 310 will be described.

Referring to FIG. 6, the main processor 310 may enter a post-start-up diagnosis mode to perform a diagnosis on whether a cooling line is airtight (or whether the coolant leaks to the outside of the stack) based on the coolant level (S610).

If an airtightness defect (e.g., a leak or a broken seal) is diagnosed (or detected) as a result of the airtightness defect diagnosis, the main processor 310 may diagnose whether the poisoning is suspected (or short-term abnormal degradation occurs) based on a channel-specific cell voltage (S620 to S630).

If the poisoning suspected cell is diagnosed as a result of diagnosing whether the poisoning is suspected, the main processor 310 may diagnose whether the poisoning is confirmed based on distribution of a segment current in the poisoning suspected diagnosis cell (S640 to S645).

If the confirmed poisoning for the corresponding cell is diagnosed as a result of diagnosing whether the poisoning is confirmed, the main processor 310 may output a predetermined warning alarm notifying diagnosis in which the coolant is introduced into the stack through a predetermined output means (S650 to S660). After outputting the warning alarm, the main processor 310 may enter the poisoning mitigation operation mode.

If the airtightness defect is not detected as a result of the diagnosis in operation 610, the main processor 310 may enter a normal operation mode.

If no poisoning suspected cell is detected as a result of the diagnosis in operation 630 or the poisoning suspected cell is not finally diagnosed as a poisoning confirmed cell as a result of the diagnosis in operation 645, the main processor 310 may output a predetermined warning alarm notifying cooling line airtightness abnormality diagnosis through a predetermined output means (S670).

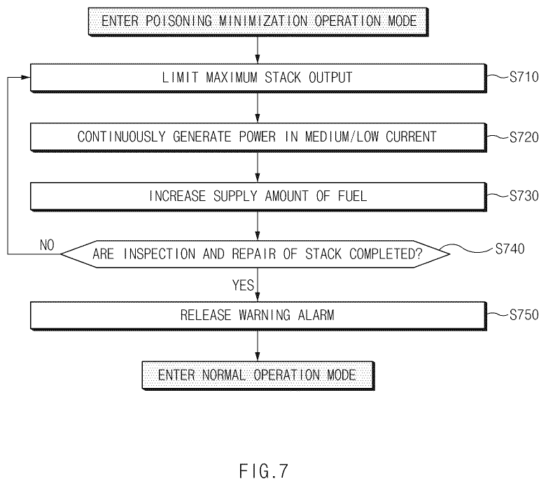

FIG. 7 is a flowchart for describing the method of diagnosing leakage of a coolant in the fuel cell system.

In detail, FIG. 7 is a flowchart for describing a poisoning mitigation method performed by the main processor 190 or 310 of the fuel cell system described above through the drawings. In the following description, an example in which the method of FIG. 7 is performed by the main processor 310 will be described.

After entering the poisoning mitigation operation mode, the main processor 310 may limit a maximum stack output to a predetermined reference value or less (S710).

The main processor 310 may control continuous power generation in the medium/low current so that a large amount of generated water is generated in the stack (S720).

The main processor 310 may increase the supply amounts of the hydrogen and the oxygen that are fuels (S730).

Through operations S710 to S730, the coolant leaking into the stack may be quickly discharged to the outside of the stack, so that the performance of the stack degraded by the poisoning may be quickly restored.

After the stack is completely inspected and repaired, the main processor 310 may release the pre-generated warning alarm and enter the normal operation mode (S740 to 750).

The poisoning operation mitigation mode according to the present disclosure is an operation mode of preventing the coolant from being additionally introduced into the electrolyte membrane and effectively discharging the coolant remaining inside the stack. The poisoning operation mitigation mode may be an operation mode of mitigating the amount of the supplied coolant in the stack by reducing the amount of the coolant required for cooling the stack by limiting stack power generation output and discharging the poisoned coolant component from the separation plate and the GDL to the outside of the stack as quickly as possible by increasing the amounts of the hydrogen and the air (e.g., the oxygen) to excessive amounts.

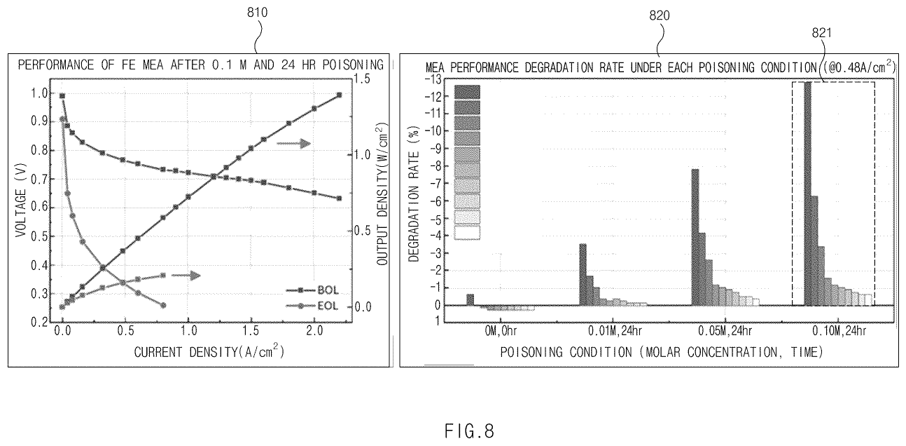

FIG. 8 illustrates a poisoning principle test result.

Reference numeral 810 illustrates a performance curve after a fuel cell membrane electrode assembly (FE MEA) has been poisoned for 0.1 mol for 24 hours. Reference numeral 820 illustrates an FE MEA performance degradation rate for each poisoning condition.

As illustrated in reference numeral 810, it is illustrated that a channel output voltage and a cell output density after the poisoning are significantly degraded as compared to a new product.

Reference numeral 820 illustrates an example degradation rate according to repeated performance under each poisoning condition at 0.48 A/cm² that is a current density frequently used during actual vehicle driving. The poisoning condition may be classified based on a molar concentration (M) and an exposure (or poisoning) time hr.

Referring to reference numeral 821, under a condition of 0.1 M and 24 hours, a degradation rate may be about −12.7% at a first time, is about −6.2% at a second time, is about −3.5% at a third time, and is about −1.5% at a fourth time. That is, it may be seen that a performance degradation rate increases as the molar concentration increases for the same exposure time.

The method of diagnosing leakage of a coolant may identify, as a voltage failure suspected channel, a channel in which a channel voltage at a predetermined operating current density (e.g., 0.48 A/cm²) is smaller than a target voltage at the corresponding operating current density by a certain level (e.g., 5%) or more and may diagnose a cell of the corresponding channel as the poisoning suspected cell when a voltage of the identified voltage failure suspected channel is decreased by a certain level (e.g., 5%) or more, as compared to the previous driving. When the cell is diagnosed as the poisoning suspected cell, current distribution analysis for the corresponding cell may be performed.

As illustrated in the test result of FIG. 8, the poisoning principle test at a current density of 0.48 A/cm² illustrates a performance reduction of 5% or more, and thus it may be determined that 5% is a level exceeding a performance error.

The fuel cell stack may illustrate various poisoning forms.

For example, traces of poisoning may be identified in the GDL, inside the separation plate, in a cathode line of the separation plate, and in a sub-gasket that is an inlet/outlet of the coolant. The sub-gasket serves to seal the electrolyte membrane and the separation plate (bipolar plate) therebetween.

If the stack is operated with high current, the flow rates of the hydrogen and the air may also increase, and accordingly, diffusion of the reaction part of the EG may be further intensified. In particular, the poisoning may occur severely around the cathode electrode CA into which oxygen is injected.

If an electrode part of the cell is exposed to or poisoned with the coolant, catalytic activity may rapidly decrease, the electrochemical reaction may decrease, and thus, a significant current reduction may occur at a poisoned location.

The present disclosure may minimize performance degradation of the fuel cell stack by performing the diagnosis of poisoning in the cell based on the current reduction phenomenon caused by the poisoning.

Further, the main processor 190 or 310 according to the present disclosure may quickly restore the degraded performance of the stack by performing poisoning mitigation if the diagnosis is confirmed as the poisoning and may prevent a fatal stack damage in the future in advance by making a driver aware of the need for inspection and repair of the stack by outputting a warning alarm according to the diagnosis of the stack as the poisoning through an instrument panel.

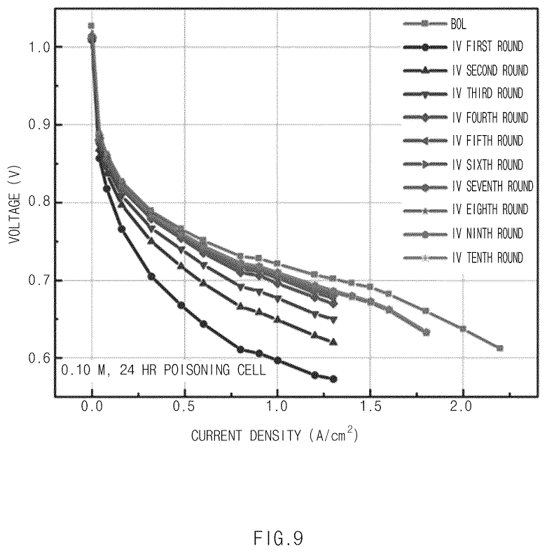

FIG. 9 is a graph depicting degradation recovery performance according to a poisoning mitigation operation.

In detail, FIG. 9 illustrates degradation recovery performance of the fuel cell stack due to the generation and discharge of the water through the poisoning mitigation operation without additional coolant input in a state in which a smaller amount of the coolant is poisoned.

As illustrated in FIG. 9, it is illustrated that a voltage of the fuel cell stack poisoned cell significantly increases at a certain current density or more according to the number of times of repeated performances of the poison mitigation operation. That is, it is illustrated that the degradation of the poisoned cell is quickly recovered.

Referring to FIG. 9, if the fuel cell stack continuously generates power at a medium/low current (e.g., a current density of 1.0 A/cm 2 ), a large amount of the generated water may be generated in the stack and discharged, and thus it may be seen that the degradation of the poisoned cell is quickly improved.

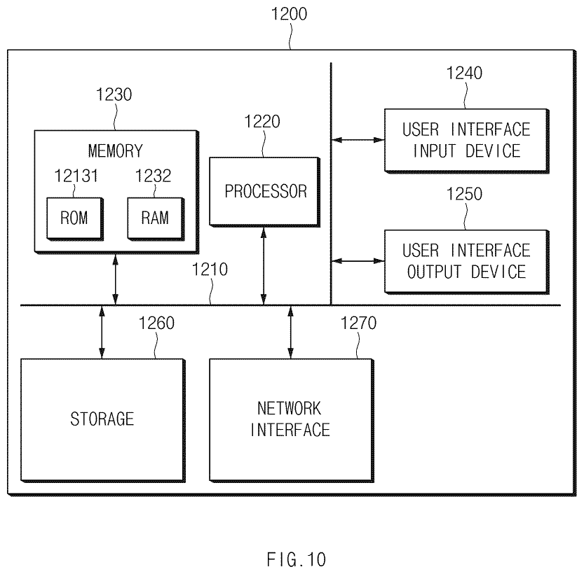

FIG. 10 illustrates a computing device. A computing device 1200 may be used to implement any one or more components, units, parts, elements, modules, devices, etc. that are disclosed herein.

Referring to FIG. 10, a computing device 1200 may include at least one of at least one processor 1220, a memory 1230, a user interface input device 1240, a user interface output device (also referred to as an output interface) 1250, storage 1260, and a network interface 1270 that are connected through a bus 1210.

The processor 1220 may be a central processing unit (CPU) or a semiconductor device that processes commands stored in the memory 1230 and/or the storage 1260. The memory 1230 and the storage 1260 may include various types of volatile or nonvolatile storage media. For example, the memory 1230 may include a read only memory (ROM) 1231 and a random-access memory (RAM).

Thus, the operations of the method (or procedure) or the algorithm described herein may be directly implemented by hardware modules, software modules, or a combination of both the hardware modules and the software modules, which are executed by the processor 1220. The software module may reside in a storage medium (that is, the memory 1230 and/or the storage 1260) such as a RAM, a flash memory, a ROM, an erasable programmable ROM (EPROM), an electrically erasable programmable ROM (EEPROM), a register, a hard disk, a removable disk, and a compact disk ROM (CD-ROM). As an example, the processor 1220 may constitute a portion of the above-described fuel cell vehicle system.

An exemplary storage medium may be coupled to the processor 1220, and the processor 1220 may read information from the storage medium and write information in the storage medium. In another manner, the storage medium may be formed integrally with the processor 1220. The processor and the storage medium may reside inside an application-specific integrated circuit (ASIC). The ASIC may also reside in an in-vehicle controller. In another manner, the processor 1220 and the storage medium may also reside as individual components within the vehicle controller or the vehicle system.

According to an aspect of the present disclosure, a method of diagnosing leakage of a coolant in a fuel cell system includes a first diagnosis operation of diagnosing whether airtightness of a cooling line is abnormal based on a coolant level of coolant storage, a second diagnosis operation of diagnosing poisoning due to the leakage of the coolant based on voltage and current measurement results of a fuel cell stack when it is diagnosed that the airtightness is abnormal, and an operation of performing a poisoning minimization operation based on the diagnosis of the poisoning.

The first diagnosis operation may include calculating a normal coolant reduction amount corresponding to an operating time at immediately previous driving, calculating a difference value between a first coolant level corresponding to an immediately previous start-up time and a second coolant level at a current start-up time, and diagnosing that the airtightness is abnormal based on the difference value that is decreased by a predetermined ratio or more as compared to the coolant reduction amount.

The first diagnosis operation may further include determining a coolant expansion coefficient corresponding to an outside air temperature at the immediately previous start-up time and an outside air temperature at the current start-up time and correcting the first coolant level and the second coolant level based on the coolant expansion coefficient, wherein the airtightness is diagnosed to be abnormal based on the difference value calculated based on the corrected first coolant level and the corrected second coolant level, which is decreased by a predetermined first ratio or more as compared to the coolant reduction amount.

The first ratio may be 5%.

The second diagnosis operation may include performing a poisoning suspecting diagnosis based on a value obtained by measuring a channel-specific voltage of the fuel cell stack and performing a poisoning confirming diagnosis based on distribution of a segment current of a poisoning suspected diagnosis cell.

At least one cell corresponding to a channel of which a voltage is reduced as compared to an immediately previous operation among a channel of which a voltage is reduced as compared to a target voltage corresponding to a predetermined operating current density may be diagnosed as a poisoning suspected cell.

The poisoning suspected diagnosis cell may be diagnosed as a poisoning confirmed cell based on a decrease ratio of a minimum value of the segment current corresponding to a current operation to a minimum value of the segment current corresponding to an immediately previous operation and an increase ratio of a standard deviation of the segment current corresponding to the current operation to a standard deviation of the segment current corresponding to the immediately previous operation.

The operation of performing the poisoning minimization operation may include at least one of limiting a maximum output of the fuel cell stack to a first reference value or less, controlling a current to generate a predetermined level or more of generated water in the fuel cell stack, and increasing fuel supply of the fuel cell stack.

The method may include an operation of generating a warning alarm based on the first diagnosis result and the second diagnosis result and an operation of displaying the generated warning alarm through a predetermined output means provided in a corresponding vehicle.

The output means may include at least one of an instrument panel, a head-up display, an audio video navigation (AVN), and a speaker, and the warning alarm may be released based on completion of inspection and repair of the fuel cell stack.

According to another aspect of the present disclosure, a computing device provided in a fuel cell vehicle system includes a processor that executes commands and a memory that stores the commands, wherein the processor diagnoses whether airtightness of a cooling line is abnormal based on a coolant level of coolant storage, diagnoses poisoning due to leakage of a coolant based on voltage and current measurement results of a fuel cell stack when it is diagnosed that the airtightness is abnormal, and performs a poisoning minimization operation based on the diagnosis of the poisoning.

The processor may calculate a normal coolant reduction amount corresponding to an operating time at immediately previous driving, calculate a difference value between a first coolant level corresponding to an immediately previous start-up time and a second coolant level at a current start-up time, and diagnose that the airtightness is abnormal based on the difference value that is decreased by a predetermined ratio or more as compared to the coolant reduction amount.

The processor may determine a coolant expansion coefficient corresponding to an outside air temperature at the immediately previous start-up time and an outside air temperature at the current start-up time and correct the first coolant level and the second coolant level based on the coolant expansion coefficient, and the airtightness is diagnosed to be abnormal based on the difference value calculated based on the corrected first coolant level and the corrected second coolant level, which is decreased by a predetermined first ratio or more as compared to the coolant reduction amount.

The first ratio may be 5%.

The processor may perform a poisoning suspecting diagnosis based on a value obtained by measuring a channel-specific voltage of the fuel cell stack and perform a poisoning confirming diagnosis based on distribution of a segment current of a poisoning suspected diagnosis cell.

The processor may diagnose, as a poisoning suspected cell, at least one cell corresponding to a channel of which a voltage is reduced as compared to an immediately previous operation among a channel of which a voltage is reduced as compared to a target voltage corresponding to a predetermined operating current density.

The processor may diagnose the poisoning suspected diagnosis cell as a poisoning confirmed cell based on a decrease ratio of a minimum value of the segment current corresponding to a current operation to a minimum value of the segment current corresponding to an immediately previous operation and an increase ratio of a standard deviation of the segment current corresponding to the current operation to a standard deviation of the segment current corresponding to the immediately previous operation.

The processor may perform the poisoning minimization operation using at least one of a means of limiting a maximum output of the fuel cell stack to a first reference value or less, a means of controlling a current to generate a predetermined level or more of generated water in the fuel cell stack, and a means of increasing fuel supply of the fuel cell stack.

The processor may control to generate a warning alarm based on the first diagnosis result and the second diagnosis result and to display the generated warning alarm through a predetermined output means provided in a corresponding vehicle.

The output means may include at least one of an instrument panel, a head-up display, an audio video navigation (AVN), and a speaker, and the processor may release the warning alarm based on completion of inspection and repair of the fuel cell stack.

The present technology provides a method of diagnosing leakage of a stack coolant in a fuel cell electric vehicle, and a device therefor.

Further, the present technology may restore performance of a stack and minimize degradation of the stack by automatically performing poisoning minimization operation logic when introduction of a coolant into the stack is detected based on a change of an electrical state in the stack.

Further, the present technology may be expected to prevent additional degradation of a stack by inducing quick inspection and repair by diagnosing whether the coolant is introduced into the stack as well as whether airtightness of a fuel cell cooling system is abnormal and by outputting a warning alarm according thereto.

In addition, various effects directly or indirectly identified though the present document may be provided.

The above description is merely illustrative of the technical spirit of the present disclosure, and those skilled in the art to which the present disclosure belongs may make various modifications and changes without departing from the essential features of the present disclosure.

Thus, the one or more example embodiments disclosed in the present disclosure are not intended to limit the technology spirit of the present disclosure, but are intended to describe the present disclosure, and the scope of the technical spirit of the present disclosure is not limited by these example embodiments. The scope of protection of the present disclosure should be interpreted by the appended claims, and all technical spirits within the scope equivalent thereto should be interpreted as being included in the scope of the present disclosure.

What is claimed is:

1. A method performed by an apparatus of a fuel cell system, the method comprising:
performing, based on detecting a coolant level of coolant storage in the fuel cell system, a first diagnosis of whether airtightness of a cooling line in the fuel cell system is abnormal;
performing, based on the first diagnosing indicating that the airtightness of the cooling line is abnormal and based on voltage and current measurements of a fuel cell stack in the fuel cell system, a second diagnosis of contamination of the fuel cell stack due to leakage of a coolant in the coolant storage; and
adjusting, based on the second diagnosis of contamination of the fuel cell stack, at least one operation of the fuel cell system that causes a contamination mitigation on the fuel cell stack.

2. The method of claim 1, wherein the first diagnosis comprises:
determining a threshold coolant reduction amount corresponding to a time duration of a most recent drive session, before a present drive session, of the fuel cell system;
determining a difference between a first coolant level corresponding to a first start-up time of the most recent drive session before the present drive session and a second coolant level at a second start-up time of the present drive session; and
diagnosing that the airtightness is abnormal based on the difference and the threshold coolant reduction amount.

3. The method of claim 2, wherein the first diagnosis further comprises:
determining a first coolant expansion coefficient corresponding to a first outside air temperature at the first start-up time;
determining a second coolant expansion coefficient corresponding to a second outside air temperature at the second start-up time;
adjusting, based on the first coolant expansion coefficient, the first coolant level;
adjusting, based on the second coolant expansion coefficient, the second coolant level; and
diagnosing the airtightness of the cooling line to be abnormal based on a difference, between the adjusted first coolant level and the adjusted second coolant level, and the threshold coolant reduction amount.

4. The method of claim 2, wherein the diagnosing that the airtightness is abnormal is further based on the difference being greater than the threshold coolant reduction amount by more than a predetermined ratio, and
wherein the predetermined ratio is 5%.

5. The method of claim 1, wherein the second diagnosis comprises:
performing, based on a channel-specific voltage of the fuel cell stack, a first contamination diagnosis to identify a cell, of the fuel cell stack, that is suspected of contamination; and
performing a second contamination diagnosis based on a distribution of a segment current of the cell suspected of contamination.

6. The method of claim 5, wherein the first contamination diagnosis comprises:
identifying the cell to be suspected of contamination, based on the cell belonging to a channel among one or more channels of the fuel cell stack, wherein a voltage of the channel during a present drive session of the fuel cell system is less than:
a voltage of the channel during a most recent drive session, before the present drive session, of the fuel cell system, and
a target voltage corresponding to a predetermined operating current density of the fuel cell system.

7. The method of claim 5, wherein the second poisoning diagnosis comprises:
confirming the cell suspected of contamination as a confirmed contaminated cell based on at least one of:
a decrease ratio of a first minimum value, during a present drive session of the fuel cell system, of the segment current relative to a second minimum value, during a most recent drive session of the fuel cell system before the present drive session, of the segment current, or
an increase ratio of a first standard deviation, during the present drive session, of the segment current relative to a second standard deviation, during the most recent drive session, of the segment current.

8. The method of claim 1, wherein the contamination mitigation comprises at least one of:
limiting a maximum output of the fuel cell stack to a first reference value or less;
controlling a current of the fuel cell stack such that the fuel cell stack generates water at a predetermined level or greater; or
increasing fuel supply of the fuel cell stack.

9. The method of claim 1, further comprising:
outputting, via an output interface and based on the first diagnosis and the second diagnosis, a warning alarm.

10. The method of claim 9, wherein the output interface comprises at least one of: an instrument panel, a head-up display, an audio video navigation (AVN), or a speaker, and
wherein the outputting of the warning alarm comprises outputting the warning alarm based on a detected repair status of the fuel cell stack.

11. An apparatus comprising:
a processor; and
a memory storing at least one instruction that is configured, when executed by the processor communicating with the memory, to cause the apparatus to:
diagnose, based on detecting a coolant level of coolant storage in a fuel cell system of a fuel cell system, whether airtightness of a cooling line in the fuel cell system is abnormal;
diagnose, based on the airtightness of the cooling line being diagnosed as being abnormal and based on voltage and current measurements of a fuel cell stack in the fuel cell system, contamination of the fuel cell stack due to leakage of a coolant in the coolant storage; and
adjust, based on the diagnosing of contamination of the fuel cell stack, at least one operation of the fuel cell system that causes a contamination mitigation operation on the fuel cell stack.

12. The apparatus of claim 11, wherein the at least one instruction is configured, when executed by the processor communicating with the memory, to cause the apparatus to diagnose whether the airtightness is abnormal by:
determining a threshold coolant reduction amount corresponding a time duration of a most recent drive session, before a present drive session, of the fuel cell system;
determining a difference between a first coolant level corresponding to a first start-up time of the most recent drive session before the present drive session and a second coolant level at a second start-up time of the present drive session; and
diagnosing that the airtightness is abnormal based on the difference and the threshold coolant reduction amount.

13. The apparatus of claim 12, wherein the at least one instruction is configured, when executed by the processor communicating with the memory, to cause the apparatus to diagnose whether the airtightness is abnormal further by:
determining a first coolant expansion coefficient corresponding to a first outside air temperature at the first start-up time;
determining a second coolant expansion coefficient corresponding to a second outside air temperature at the second start-up time;
adjusting, based on the first coolant expansion coefficient, the first coolant level;
adjusting, based on the second coolant expansion coefficient, the second coolant level; and
diagnosing the airtightness of the cooling line to be abnormal based on a difference, between the adjusted first coolant level and the adjusted second coolant level, and the threshold coolant reduction amount.

14. The apparatus of claim 12, wherein the diagnosing that the airtightness is abnormal is further based on the difference being greater than the threshold coolant reduction amount by more than a predetermined ratio, and
wherein the predetermined ratio is 5%.

15. The apparatus of claim 11, wherein the at least one instruction is configured, when executed by the processor communicating with the memory, to cause the apparatus to diagnose contamination of the fuel cell stack by:
performing, based on a channel-specific voltage of the fuel cell stack, a first contamination diagnosis to identify a cell, of the fuel cell stack, that is suspected of contamination; and
performing a second contamination diagnosis based on a distribution of a segment current of the cell suspected of contamination.

16. The apparatus of claim 15, wherein the at least one instruction is configured, when executed by the processor communicating with the memory, to cause the apparatus to perform the first contamination diagnosis by:
identifying the cell to be suspected of contamination, based on the cell belonging to a channel among one or more channels of the fuel cell stack, wherein a voltage of the channel during a present drive session of the fuel cell system is less than:
a voltage of the channel during a most recent drive session, before the present drive session, of the fuel cell system, and
a target voltage corresponding to a predetermined operating current density of the fuel cell system.

17. The apparatus of claim 15, wherein the at least one instruction is configured, when executed by the processor communicating with the memory, to cause the apparatus to perform the second contamination diagnosis by:
confirming the cell suspected of contamination as a confirmed poisoned cell based on at least one of:
a decrease ratio of a first minimum value, during a present drive session of the fuel cell system, of the segment current relative to a second minimum value, during a most recent drive session of the fuel cell system before the present drive session, of the segment current, or an increase ratio of a first standard deviation, during the present drive session, of the segment current relative to a second standard deviation, during the most recent drive session, of the segment current.

18. The apparatus of claim 11, wherein the at least one instruction is configured, when executed by the processor communicating with the memory, to cause the apparatus to perform the contamination mitigation operation by at least one of:
limiting a maximum output of the fuel cell stack to a first reference value or less;
controlling a current of the fuel cell stack such that the fuel cell stack generates water at a predetermined level or greater; or
increasing fuel supply of the fuel cell stack.

19. The apparatus of claim 11, wherein the at least one instruction is configured, when executed by the processor communicating with the memory, to further cause the apparatus to:
output, via an output interface and based on the diagnosing of contamination of the fuel cell stack, a warning alarm, and
wherein the output interface comprises at least one of an instrument panel, a head-up display, an audio video navigation (AVN), or a speaker.

20. A vehicle comprising:
a fuel cell system comprising a fuel cell stack;
a processor; and
a memory storing at least one instruction that is configured, when executed by the processor communicating with the memory, to cause the vehicle to:
determine, based on detecting a coolant level of coolant storage in the fuel cell system and based on at least one measurement associated with a physical characteristic of the fuel cell stack, contamination of the fuel cell stack due to leakage of a coolant in the coolant storage;
adjust, based on the determined contamination of the fuel cell stack, at least one operation of the fuel cell system that causes a contamination mitigation operation on the fuel cell stack; and
control, based on the adjusted at least one operation of the fuel cell system, an operation of the vehicle, wherein the at least one measurement comprises at least one of a voltage measurement associated with the fuel cell stack or a current measurement associated with the fuel cell stack.
